(19) United States
(12) Patent Application Publication
(10) Pub. No.: US 2023/0264210 A1
(43) Pub. Date: Aug. 24, 2023

(54) REMOTE FOAM GENERATORS AND FOAM AT A DISTANCE DISPENSER SYSTEMS

(71) Applicant: GOJO Industries, Inc., Akron, OH (US)

(72) Inventor: Jeffrey S. Louis, Akron, OH (US)

(21) Appl. No.: 18/169,979

(22) Filed: Feb. 16, 2023

Related U.S. Application Data
(60) Provisional application No. 63/311,663, filed on Feb. 18, 2022.

(51) Int. Cl. B05B 7/00; A47K 5/16; B05B 7/26

(52) U.S. Cl. CPC B05B 7/0018; A47K 5/16; B05B 7/262

(57) ABSTRACT

Exemplary foam dispensers having remote foam generators and remote foam generators are disclosed herein. An exemplary foam dispenser includes a housing, a liquid reservoir, a liquid pump chamber, an air pump chamber and a remote foam generator. The remote foam generator is at least 3 inches from the liquid pump chamber and the air pump chamber. The remote foam includes a housing, an end wall, a liquid inlet and an air inlet. The remote foam generator includes a central axis. The air inlet is located above the central axis and the liquid inlet is located below the central axis. The remote foam generator includes an inner mixing chamber, an outer mixing chamber and a deflector. The deflector has a first surface angled to deflect air flowing from the air inlet into the outer mixing chamber. The liquid inlet directs liquid flow into the outer mixing chamber. One or more fluid flow windows place the outer mixing chamber in fluid communications with the inner mixing chamber. A foaming chamber is included. One or more mix media are located in the foaming chamber. The foam generator also includes a foam outlet.

### CROSS-REFERENCE TO RELATED APPLICATION(S)

This application claims priority to and the benefit of U.S. Provisional Pat. Application No. 63/311,663, filed Feb. 18, 2022, the entire disclosure of which is incorporated herein by reference in full.

### TECHNICAL FIELD

The present invention relates generally to pumps and dispenser systems, and more particularly to foam at a distance dispensing systems for mixing liquid (e.g. soap or sanitizer) with air at a location remote from a pump to create and dispense a foam-at-a-distance product.

### BACKGROUND OF THE INVENTION

Liquid dispenser systems, such as liquid soap and sanitizer dispensers, provide a user with a predetermined amount of liquid upon actuation of the dispenser. In addition, it is sometimes desirable to dispense the liquid in the form of foam by, for example, injecting air into the liquid to create a foamy mixture of liquid and air bubbles. Typically, the liquid and air are mixed together near the pump and the foam product is pushed through a dispensing tube and dispensed at a location away from the foam pump. There have been attempts to mix liquid and air at a location away from the pump, however, the foam output is often poor as the liquid and air are not mixed thoroughly enough to produce uniform small air bubbles in the foam.

### SUMMARY

Exemplary foam dispensers having remote foam generators and remote foam generators are disclosed herein. An exemplary foam dispenser includes a housing, a liquid reservoir, a liquid pump chamber, an air pump chamber and a remote foam generator. The remote foam generator is at least 3 inches from the liquid pump chamber and the air pump chamber. The remote foam includes a housing, an end wall, a liquid inlet and an air inlet. The remote foam generator includes a central axis. The air inlet is located above the central axis and the liquid inlet is located below the central axis. The remote foam generator includes an inner mixing chamber, an outer mixing chamber and a deflector. The deflector has a first surface angled to deflect air flowing from the air inlet into the outer mixing chamber. The liquid inlet directs liquid flow into the outer mixing chamber. One or more fluid flow windows place the outer mixing chamber in fluid communications with the inner mixing chamber. A foaming chamber is included. One or more mix media are located in the foaming chamber. The foam generator also includes a foam outlet.

An exemplary remote foam generator that is configured to mix air and liquid at a location away from one or more pumps that pump air and liquid separately to the remote foam generator is also disclosed herein. The remote foam generator includes a cylindrical housing, an end wall, a liquid inlet extending outward from the end wall and an air inlet extending outward from the end wall. The remote foam generator includes a central axis. The air inlet is located closer to the central axis than the liquid inlet. An inner cylindrical projection extends inward from the end wall and an outer cylindrical projection extends inward from the end wall. The air inlet in fluid communication with an area between the inner cylindrical projection and the outer cylindrical projection. The liquid inlet in fluid communication with an area between the outer cylindrical projection and an inside wall of the cylindrical housing. The foam generator includes an outer mixing chamber, an inner mixing chamber and a deflector. The deflector includes a mixing chamber separator and a deflecting surface. The deflecting surface deflects air flowing from the air inlet into the outer mixing chamber. A foaming chamber, one or more mix media located in the foaming chamber and a foam outlet are also included.

Another exemplary foam dispenser includes a housing, a liquid reservoir, a liquid pump chamber, an air pump chamber and a remote foam generator. The remote foam generator is at least 3 inches from the liquid pump chamber and the air pump chamber. The remote foam generator has a cylindrical housing, a liquid inlet and an air inlet. The air inlet located above the liquid inlet. The remote foam generator includes an inner mixing chamber and an outer mixing chamber. The outer mixing chamber has an interior wall. A first air passage directing the air into the outer mixing chamber is also included. The first air passage has an outer wall. The outer wall of the first air passage is located away from the interior wall of the outer mixing chamber. The liquid inlet directs liquid flow into the outer mixing chamber. One or more fluid flow windows place the outer mixing chamber in fluid communications with the inner mixing chamber. A foaming chamber, one or more mix media located in the foaming chamber and a foam outlet are also included.

### BRIEF DESCRIPTION OF THE DRAWINGS

FIG. 1 is an exemplary embodiment foam dispensing system having a sequentially operated multi-diaphragm pump, a mixing chamber and foam output, with the mixing chamber located away from the pump;

FIG. 2 is an isometric view of an exemplary sequentially operated multi-diaphragm pump and motor for pumping air and liquid to the mixing chamber that is located the pump;

FIG. 3 is an exploded view of the exemplary embodiment of the sequentially activated multi-diaphragm pump and motor of FIG. 2;

FIG. 4 is a cross-sectional view of the exemplary sequentially operated multi-diaphragm pump and motor of FIG. 2 showing the side port liquid inlet, liquid outlet and air outlet;

FIG. 5 is another cross-sectional view of the exemplary sequentially operated multi-diaphragm pump and motor of FIG. 2 showing the liquid outlet and the air outlet;

FIG. 6 is an isometric view of another exemplary sequentially operated multi-diaphragm pump and motor having a liquid inlet port that is parallel to the liquid outlet port and the air outlet port;

FIG. 7 is an exploded view of the exemplary embodiment of the sequentially activated multi-diaphragm foam-at-a-distance pump and motor of FIG. 6;

FIG. 8 is a cross-section of the exemplary sequentially operated multi-diaphragm pump and motor of FIG. 6 showing the air outlet port and two of the air pumping chambers; and

FIG. 9 is another cross-section of the exemplary sequentially operated multi-diaphragm pump and motor of FIG. 6 showing the parallel liquid inlet port and liquid outlet port;

FIG. 10 is a prospective view of an exemplary remote foam generator;

FIG. 11 is a exploded view of the exemplary remote foam generator of FIG. 10;

FIG. 12 is a cross-sectional view of the exploded view of FIG. 11;

FIG. 13 is a cross-sectional view of a portion of the exemplary remote foam generator of FIG. 10;

FIG. 14 is a side view of the portion of the exemplary remote foam generator of FIG. 15;

FIG. 15 is a cross-sectional view along a vertical axis of the exemplary remote foam generator of FIG. 10;

FIG. 16 is a cross-sectional view along a horizontal axis of the exemplary remote foam generator of FIG. 10; and

FIGS. 17 and 18 illustrate the fluid flow through the exemplary foam generator.

### DETAILED DESCRIPTION

The present application discloses exemplary embodiments of foam dispensers and dispensing systems having a remote foam generator that is located away from the pump. The remote foam generator disclosed herein may be used with a single pump that pumps liquid and pumps air, wherein the liquid and air are pumped separately. Exemplary pumps include, for example, a sequentially activated multi-diaphragm pump, a dual displacement pump, a dual piston pump, or even two separate pumps. Some exemplary embodiments utilize sequentially activated pumps that include a wobble plate and three or more pump diaphragms. The three or more pump diaphragms include at least one liquid pump diaphragm and at least two air pump diaphragms. Each liquid pump diaphragm has a liquid inlet for receiving liquid, such as, for example, a soap or a sanitizer, and each air pump diaphragm has an air inlet for receiving air. The pump has two separate outlets, a liquid pump outlet and an air pump outlet.

The term “remote” as used herein means that the remote foam generator is located at least 3″ from the liquid outlet and air outlet of the pump.

The single sequentially activated multi-diaphragm pumps disclosed herein, pumps liquid and air through separate conduits to the remote foam generator where the liquid and air are mixed together. The remote foam generator includes an outlet for dispensing foam into a user’s hand. In some exemplary embodiments, the remote foam generator is located at a point higher than the pump. In some embodiment, the sequentially activated multi-diaphragm pump is located below a countertop and the remote foam generator is located above the countertop. In some embodiments, the sequentially activated multi-diaphragm pump is located in the base of a dispenser and the remote foam generator and outlet nozzle are located near the top of the dispenser.

In some embodiments of the present invention, the foam that is dispensed is created with an air to liquid ratio of between about 5 to 1 and about 15 to 1. In some embodiments, the air to liquid ratio between about 6 to 1 and about 12 to 1. In some embodiments, the air to liquid ratio between about 7 to 1 and about 10 to 1. In some embodiments, the air to liquid ratio between about 8 to 1 and about 12 to 1. In some embodiments, the air to liquid ratio between about 9 to 1 and about 12 to 1. In some embodiments, the air to liquid ratio between about 10 to 1 and about 12 to 1.

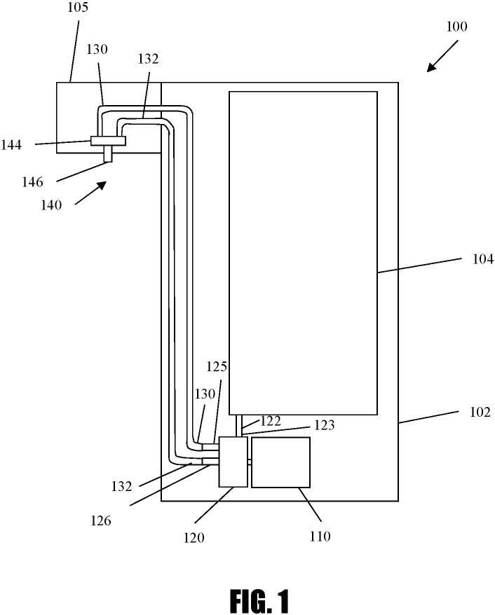

FIG. 1 illustrates an exemplary embodiment of a dispenser 100. In this exemplary embodiment, dispenser 100 is a self-contained dispenser and sits on a counter top, a table, or the like. In some embodiments, the dispenser may be a counter-mount dispenser (not shown) having a spout located above the countertop and the pump and container located below the counter top. In some embodiments, dispenser 100 is a surface mounted dispenser, such as, for example, a wall mounted dispenser or a stand mounted dispenser.

Dispenser 100 includes a housing 102. A removable and replaceable refill unit or reservoir 104 is included. The refill unit or reservoir 104 is in fluid communication with a liquid inlet of pump 120 through conduit 122. In this exemplary embodiment, reservoir 104 is located within housing 102. In some embodiments, reservoir 104 is located partially within housing 102. In some embodiments, reservoir 104 is located on top of at least a portion of housing 102. In some embodiments, reservoir 104 is located at the bottom of housing 102. In some embodiments, at least a portion of the reservoir 104 is located below the housing 102. In some embodiments, at least a portion of the reservoir 104 is visible during use.

The term reservoir, container or bottle may be used interchangeably. In addition, in some embodiments, a refill unit may also be used interchangeably with container, bottle or reservoir. The term refill unit means a container, reservoir or bottle that may be readily removed from the dispenser and replaced with a new refill unit. A refill unit may include a closure, a liquid outlet, an air inlet, or the like. In some embodiments, a refill unit may include a pump.

In this exemplary embodiment, reservoir 104 is a sealed reservoir and is a non-collapsing reservoir. Accordingly, a vent valve (not shown) is included in this embodiment. In some embodiments, reservoir 104 is a collapsing reservoir and a vent valve is not required. Preferably when a reservoir 104 is a collapsing reservoir, the reservoir is located within housing 102 so as to not be visible to a consumer unless the dispenser is opened up.

Located in the base of housing 102 is a motor 110 and a pump 120. In this exemplary embodiment, pump 120 is a sequentially activated multi-diaphragm pump and is located bellow reservoir 104. In some embodiments, pump 120 is located above reservoir 104. In some embodiments, pump 120 is one or more displacement pumps. In some embodiments, pump 120 is a dual piston pump. In some embodiments, pump 120 is a pair of piston pumps.

In this exemplary embodiment, liquid inlet 123 is located on the side of sequentially activated multi-diaphragm pump 120 and is substantially perpendicular to air outlet 125. Sequentially activated multi-diaphragm pump 120 has a liquid outlet 126. Liquid outlet 126 is located along a central axis of pump 120. In this exemplary embodiment, air outlet 125 is offset from the central axis.

Air outlet 125 is in fluid communication with remote foam generator 140 through air conduit 130. Liquid outlet 126 is in fluid communication with the remote foam generator 140 through liquid conduit 132.

Over each operating cycle, multi-diaphragm pump 120 pumps a discrete dose of liquid into liquid conduit 132 and two or more discrete doses of air into air conduit 130. Once the liquid conduit 132 is filled with liquid, each operating cycle dispenses a discrete dose of liquid into remote foam generator 140. The volume of the discrete dose of liquid pumped into the mixing chamber is consistent and the flow rate into the remote flow generator are consistent. Similarly, each operating cycle dispenses at least two discrete volumes of air into the remote foam generator 140. The volumes and flow rate of air into the remote foam generator are consistent. Multiple operating cycles are required for each dose of foam that is dispensed from the outlet.

Liquid and air are mixed together in remote foam generator 140. The mixture may be forced through an optional foaming media, which may be one or more screens and/or a sponge, and is dispensed out of dispensing outlet 146 as a foam.

In this exemplary embodiment, remote foam generator 140 and dispensing outlet 146 are located in an overhanging section 105 of housing 102. Dispensing outlet 146 is located in a position that allows a user to place her hand under the dispensing outlet 146 and receive a dose of foam.

Dispenser 100 includes electrical components (not shown) that are required for operating dispenser 100 in a touch-free manner. The electrical components include: one or more power sources, such as, for example, one or more batteries; a microprocessor; a sensor for sensing an object proximate the outlet nozzle; circuitry for activating the sequentially activated multi-diaphragm pump 120; logic for causing the processor to control the functions of the dispenser 100; indicating lights; and any other circuitry required to perform the require functions. Some exemplary touch-free dispenser components that may be used in accordance with the present invention are shown and described in U.S. Pat. No, 8,960,498 titled Touch-Free Dispenser With Single Cell Operation And Battery Banking; U.S. Pat. Pub. No. 2014/00543.22 titled Off-Axis Inverted Foam Dispensers And Refill Units and Pub. No. 2014/0234140 titled Power Systems For Touch Free Dispensers And Refill Units Containing a Power Source, which are incorporated herein by reference in their entirety.

In some embodiments, dispenser 100 is a manual dispenser. In that embodiment, preferably, pump 120 is a dual piston displacement pump and is manually operated, by for example, pushing a push bar, pushing down on the dispenser, or the like.

In some embodiments, the dispenser may be a counter-mount dispenser (not shown) having a spout located above the countertop with the remote mixing chamber located in the spout proximate an outlet of the spout, and the sequentially activated multi-diaphragm pump being located below the countertop. In addition, the reservoir is located below the countertop.

Reservoir 104 is preferably removable and replaceable. Accordingly, when reservoir 104 is out of fluid or needs replaced, reservoir 104 may be removed from dispenser 100 and a new reservoir 104 may be installed. In some embodiments, reservoir 104 may be a permanent reservoir that has soap or sanitizer added to it when the fluid runs out. Preferably, if the reservoir 104 is a refill unit, the reservoir 104 includes a body and a neck (not shown) and a drip-free quick connector (not shown) so that the reservoir 104 may be removed from dispenser 100 even if it contains fluid without leaking that fluid. Exemplary drip-free quick connectors are disclosed in U.S. Pat. No. 6,871,679 titled Bag and Dispensing System Comprising Such A Bag, and U.S. Pat. No. 7,647,954 titled Connector Apparatus And Method For Connecting The Same For Controlling Fluid Dispensing, which are incorporated herein by reference in their entirety.

Reservoir 104 contains a supply of a foamable liquid. In various embodiments, the contained foamable liquid could be for example a soap, a sanitizer, a cleanser, a disinfectant, a lotion or the like. The reservoir 104 may be a collapsible container and can be made of thin plastic or a flexible bag-like material. In other embodiments, the container may be a non-collapsing container formed by a rigid or semi-rigid housing, or any other suitable configuration for containing the foamable liquid without leaking. In the case of a non-collapsing container, a vent system may be included. Exemplary venting systems are disclosed in U.S. Pat. Applications Publication No. 2015/0266657 titled Closed System for Venting a Dispenser Reservoir; Publication No. 2015/025184 titled Pumps With Container Vents and Application No. 14/811,995, titled Vented Refill Units And Dispensers Having Vented Refill Units, which are incorporated herein by reference.

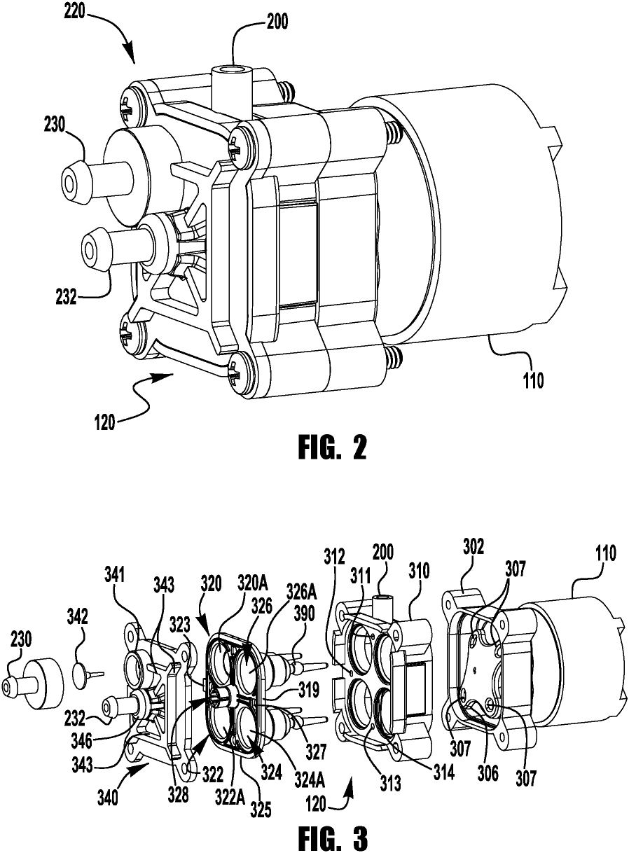

FIGS. 2-9 illustrate exemplary embodiments of sequentially activated multi-diaphragm pumps and manifolds that may be used in accordance with the present invention. Co-owned U.S. Pat. No. 10,143,339, which is incorporated herein by reference in its entirety, provides detailed workings of sequentially activated pumps for pumping both liquid and air. Many of the components in the pumps disclosed herein are described in detail in U.S. Pat. No. 10,143,339 and thus, may not be described with specificity herein.

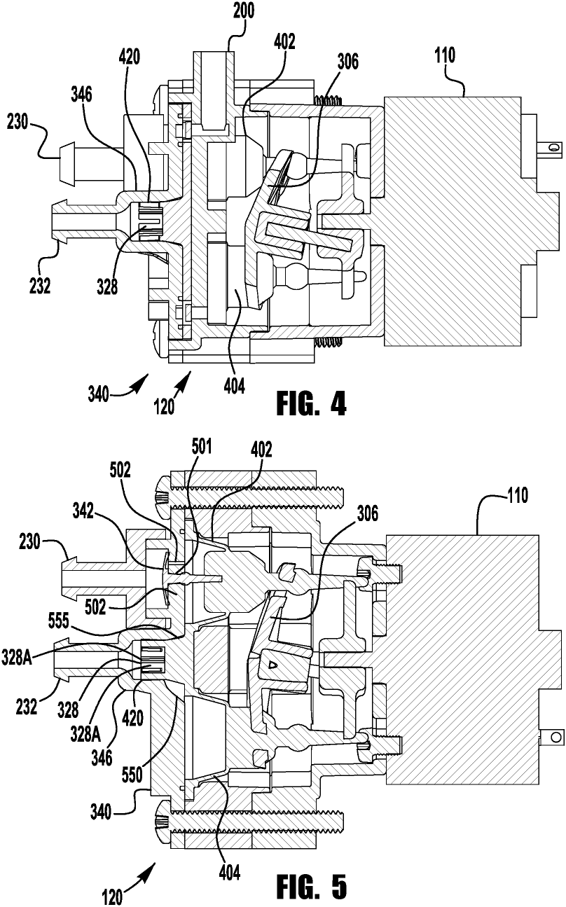

FIG. 2 is a prospective view of sequentially activated multi-diaphragm pump 120. FIG. 3 is an exploded view of sequentially activated multi-diaphragm pump 120, and FIGS. 4 and 5 are cross-sectional views of sequentially activated multi-diaphragm pump 120. Sequentially activated multi-diaphragm pump 120 includes a motor 110. Motor 110 is connected to a wobble plate 306 located in a wobble plate housing 302. Wobble plate 306 includes a plurality of connection points 307 that each connect to a liquid pump diaphragm 320 or an air pump diaphragm 322, 324, 326. Movement of the wobble plate 306 causes compression and expansion of the liquid pump diaphragm 320 and air pump diaphragms 322, 324, and 326 in a sequential fashion.

A diaphragm housing 3120 is connected to wobble plate housing 302. Diaphragm housing 310 incudes a liquid inlet 200. Liquid inlet 200 is in fluid communication with liquid inlet passage 311. Diaphragm housing 310 also includes air inlet passages 3122, 313, 314 in fluid communication with ambient air.

Diaphragm housing 310 receives multi-chamber diaphragm 319. Multi-chamber diaphragm 319 includes a liquid pump chamber 320A formed in part by liquid pump diaphragm 320, and three air pump chambers 322A, 324A, and 326A formed in part by air pump diaphragm 322, air pump diaphragm 324 and air pump diaphragm 326. Multi-chamber diaphragm 319 includes a liquid inlet valve 321. Liquid inlet valve 321 is a one-way valve that allows fluid to flow from liquid inlet 200 to the interior of liquid pump chamber 320A. Multi-chamber diaphragm 319 includes three air inlet valves 323, 325, and 327 respectfully. Air inlet valve 323 is a one-way valve that allows ambient air to flow to the interior of air pump chamber 322A. Air inlet valve 325 is a one-way valve that allows ambient air to flow to the interior of air pump chamber 324A. Air inlet valve 327 is a one-way valve that allows ambient air to flow to the interior of air pump chamber 326A. Multi-chamber diaphragm 319 also includes a one-way air outlet valve 328 that allows air to flow out of air pump chambers 322A, 324A, and 326A. In this exemplary embodiment, liquid inlet valve, 321, air inlet valves 323, 325, and 327 and one-way air outlet valve 328 are all integrally molded with multi-chamber diaphragm 319. In some embodiments, one or more of these valves are separate from multi-chamber diaphragm 319.

Secured to diaphragm housing 310 is manifold 340. In this exemplary embodiment, manifold 340 includes a central hub 346 that has a cylindrical shape. Air outlet valve 328 is located withing the central hub 346. The interior walls 420 of the central hub 346 form a seat or sealing member for air outlet valve 328. Air outlet valve 328 includes a plurality of fingers 328A that deflect inward under pressure from air being pumped from the air pump chambers 322A, 324A, and 326A to allow air to flow past the one-way air outlet valve 328. The fingers 328A seal against the interior wall 420 to prevent air from flowing from the outlet back to the air pump chambers 322A, 324A, and 326A. Air outlet port 232 is in fluid communication with central hub 346 and connects to air conduit 130

Manifold 340 includes a liquid outlet hub 341. Liquid outlet hub 341 is cylindrical in this exemplary embodiment, but may have other geometric shapes. Liquid outlet hub 341 is configured to connect to liquid outlet port 230. In this exemplary embodiment, liquid outlet port 230 has a cylindrical wall and the interior of the cylindrical wall is configured to mate with the exterior or liquid outlet hub 341 to connect the liquid outlet port 230 to manifold 340. The connection may be, for example, a friction fit, a welded connection, an adhesively bonded connection, a threaded connection or the like.

Located within liquid outlet hub 341 is a valve retention aperture 501 that receives and retains liquid outlet valve 342. In this exemplary embodiment, one or more apertures 502 are also located within liquid outlet hub 341. Apertures 502 are covered by liquid outlet valve 342, which in this exemplary embodiment is a normally closed valve. As liquid pump chamber 320A compresses, liquid flows through apertures 502 past one way-liquid outlet valve 342 and into liquid conduit 132.

Manifold 340 includes a liquid pump chamber sealing member 555. Liquid pump chamber sealing member 555 isolates the liquid pump chamber 320A from the air outlet valve 328 and prevents liquid from flowing into the air outlet port 232. Liquid pump chamber sealing member 555 prevents Liquid pump chamber sealing member 555 may be contrasted to the chamfer 550 portion of the manifold 340 located proximate the air outlet valve 328, which allows air to flow and contact the flap portion of the air outlet valve 328 to deflect to allow air to flow past. In some embodiments, liquid pump chamber sealing member is a gasket. In some embodiments, liquid pump chamber sealing member is an annular projection that seals against the multi-chamber diaphragm.

In addition, manifold 340 includes a plurality of optional ribs 343. In some embodiments, ribs 343 prevent flexing or bowing of manifold 340. Flexing or bowing of manifold 340 may result in blow by of liquid and/or air or cross-contamination of liquid and air in the liquid conduit 132 and or air conduit 130.

In this exemplary embodiment, the liquid inlet 200 is located substantially perpendicular to liquid outlet port 230. Having the liquid inlet 200 arranged substantially perpendicular to liquid outlet port 230 has several advantages over other arrangements. In some embodiments, the tortuous path through the substantially perpendicular liquid inlet 200, through the passage 311 and to the liquid pump chamber 320A aids in holding back head pressure from reservoir 104. In some embodiments, these arrangements facilitate a desired flow reducer that slows flow of liquid into the liquid pump chamber 320A.

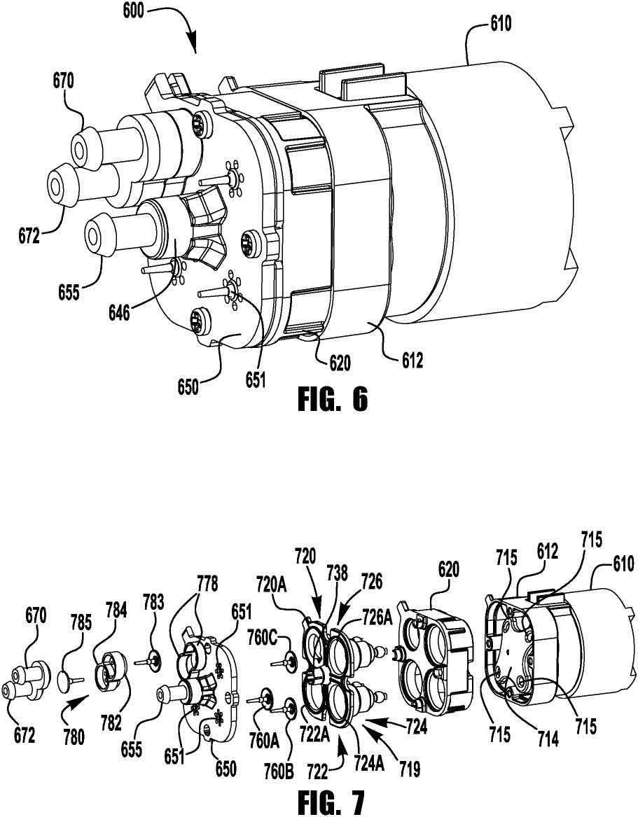

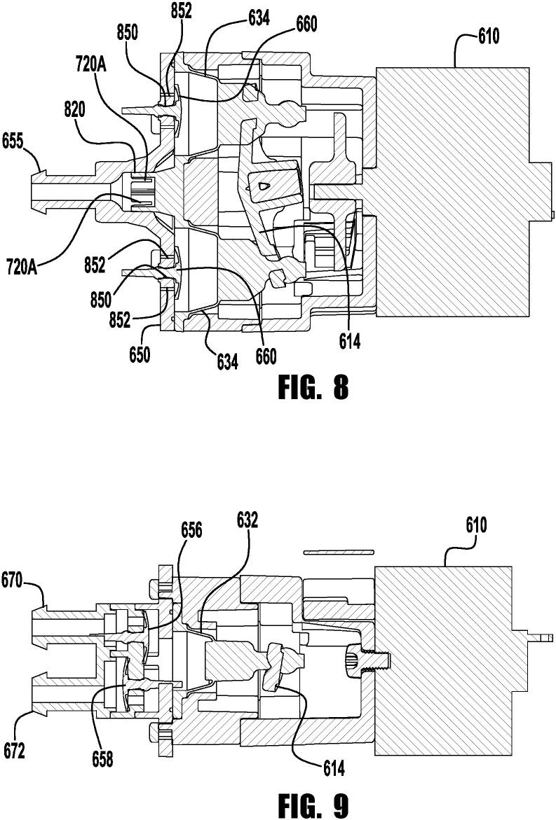

FIG. 6 is a prospective view of sequentially activated multi-diaphragm pump 600. FIG. 7 is an exploded view of the sequentially activated multi-diaphragm pump 600. FIG. 8 is a cross-sectional view of the sequentially activated multi-diaphragm pump 600 showing two of the air pump chambers and the air outlet port. FIG. 9 is a cross-sectional view of the sequentially activated multi-diaphragm pump 600 showing the liquid pump chamber, liquid inlet port and liquid outlet port. Sequentially activated multi-diaphragm pump 600 includes a motor 610. Motor 610 is connected to a wobble plate 714 located in a wobble plate housing 612. Wobble plate 714 includes a plurality of connection points 715 that each connect to a liquid pump diaphragm 720 or an air pump diaphragm 722, 724, 726. Movement of the wobble plate 714 causes compression and expansion of the liquid pump diaphragm 720 and air pump diaphragms 722, 724, and 726 in a sequential fashion.

A diaphragm housing 620 is connected to wobble plate housing 612. Diaphragm housing 620 receives multi-chamber diaphragm 719. Multi-chamber diaphragm 719 includes a liquid pump chamber 720A formed in part by liquid pump diaphragm 720, and three air pump chambers 722A, 724A, and 726A formed in part by air pump diaphragm 722, air pump diaphragm 724 and air pump diaphragm 726 respectively.

Secured to diaphragm housing 620 is manifold 650. In this exemplary embodiment, manifold 650 includes a central hub 646 that has a cylindrical shape. Air outlet valve 738 is located withing the central hub 646. The interior wall 820 of the central hub 646 forms a seat or sealing member for air outlet valve 738. Air outlet valve 738 includes a plurality of fingers 738A that deflect inward under pressure from air being pumped from the air pump chambers 722A, 724A, and 726A to allow air to flow past the one-way air outlet valve 738. The fingers 738A seal against the interior wall 820 to prevent air from flowing from the outlet back to the air pump chambers 722A, 724A, and 726A. Air outlet port 655 is in fluid communication with hub 646 and connects to an air outlet conduit (not shown).

Manifold 650 includes an air inlet valve retention aperture 850 for each air inlet valve 760A, 760B and 760C. Air inlet valves 760A, 760B and 760C are one-way inlet valves and are normally closed valves. Manifold 650 also includes one or more air inlet apertures 852 located proximate valve retention apertures 850 that allow air to flow into the air pump chambers 722A, 724A and 726A. As air pump chambers 720A, 720B and 720C expand, air flows through air inlet apertures 852 and deflect air inlet valves 760A, 760B and 760C allowing air to flow into the respective air pump chambers 722A, 724A and 726A.

Manifold 650 includes liquid valve insert retaining member 778. In this exemplary embodiment, liquid valve insert retaining member 778 comprises is an upward projecting member having two semi-circular portions. Liquid valve insert 780 is configured to connect to liquid valve insert retaining member 778. The connection may be any type of connection, permanent or semi-permanent, such as, for example, a friction fit, a welded connection, an adhesive connection, a snap-fit connection, or the like. Liquid valve insert 780 includes a liquid inlet valve retaining aperture (not shown) for retaining liquid inlet valve 783. Liquid valve insert 780 also includes one or more liquid inlet apertures (not shown) that work with one-way liquid inlet valve 783 to allow liquid to flow into the liquid pump chamber 720A and prevent liquid from flowing out of liquid pump chamber 720A.

Liquid valve insert 780 includes a liquid outlet valve retaining aperture (not shown) for retaining liquid outlet valve 785. Liquid valve insert 780 also includes one or more liquid outlet apertures (not shown) that work with one-way liquid outlet valve 785 to allow liquid to flow out of the liquid pump chamber 720A and prevent liquid from flowing into of liquid pump chamber 720A. Liquid inlet port 670 and liquid outlet port 672 are configured to connect to liquid valve insert 780 in any manner, such as those described above. A liquid inlet conduit (not shown) connects to liquid inlet port and a liquid outlet conduit (not shown) connects to liquid outlet port 672.

In this exemplary embodiment, liquid inlet port 670 is located substantially parallel to liquid outlet port 672. Having liquid inlet port 670 arranged substantially parallel to liquid outlet port 672 has several advantages over other arrangements. In some embodiments, the configuration reduces the forces required to pump the fluid. Reducing the force required to pump the fluid increases the efficiency of the sequentially activated multi-diaphragm pump 600. In embodiments, such as, for example, those operated by batteries, the increased efficiency may lead to increased battery life.

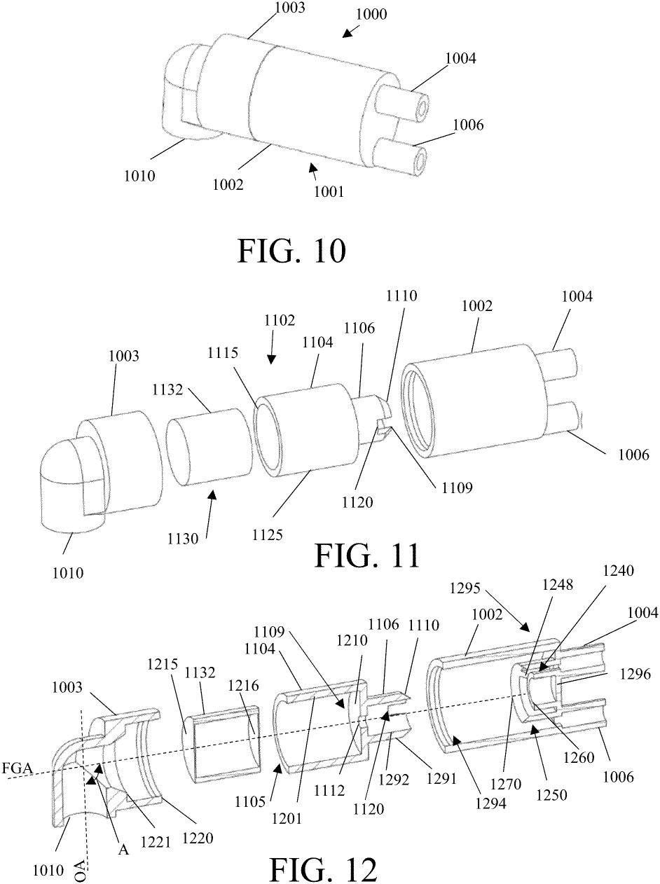

FIG. 10 is a prospective view of an exemplary remote foam generator 1000. Remote foam generator 1000 includes a housing 1001. In this exemplary embodiment, housing 1001 includes a first housing portion 1002 and a second housing portion 1003. Remote foam generator 1000 includes an air inlet 1004 and a liquid inlet 1006 and a foam outlet.

In some embodiments, air inlet 1004 may be located beside liquid inlet 1006. In some embodiments, air inlet 1004 may be located below liquid inlet 1006. In this exemplary embodiment, air inlet 1004 is located in an upper portion of the first housing portion 1002 and above liquid inlet 1006. If residual foam and/or liquid pool in remote foam generator 1000 the liquid settles to the bottom of housing 1002. Locating air inlet 1004 at the top of housing 1002 provides a benefit of preventing pooled liquid from flowing through the air inlet 1004 toward the pump (not shown). Liquid entering flowing through the air inlet 1004 toward the pump, may clog the air line and may also result in bacteria growing in the air line.

In some embodiments, the air inlet 1004 is located closer to a central axis FGA of the remote foam generator 1000 than the liquid inlet 1006. In some embodiments, the air inlet 1004 is located above the central axis FGA and the liquid inlet 1006 is located below the central axis FGA.

In some embodiments, the air inlet 1004 and air flow channel 1240 is located away from the interior wall 1201 of first housing portion 1002.

FIG. 11 is a exploded view of the exemplary remote foam generator 1000 and FIG. 12 is an exploded cross-sectional view. Remote foam generator includes a diverter 1102. Diverter 1102 includes a cylindrical shell 1104. Cylindrical shell 1104 has an open end 1105 and an outer end 1109. Outer end 1109 includes a wall plate 1210. A fluid flow restrictor aperture 1112 is located in the wall plate 1210. In this exemplary embodiment, fluid flow through aperture 1212 is a flow reducer. As discussed in more detail below, restrictor aperture 1112 has a diameter that is smaller than the diameter of the inner mixing chamber 1504 (FIG. 15). Cylindrical shell 1104 is sized to receive foaming cartridge 1130.

Foaming cartridge 1130 includes a cylindrical housing 1132. In this exemplary embodiment, foaming cartridge 1130 includes a first screen 1215 located on a first end of cylindrical housing 1132 and a second screen 1216 located on a second end of cylindrical housing 1132. In some embodiments, a sponge (not shown) is located within the interior of cylindrical housing 1132. In some embodiments, the sponge (not shown) is in addition to the two screens 12215, 1216. In some embodiments, the sponge (not shown) is in lieu of the two screens 1215, 1216. Cylindrical housing 1132 is preferably a snug fit in cylindrical shell 1104 so that fluid does not flow around cylindrical housing 1132.

Second housing portion 1003 has a cylindrical body 1220. Located within cylindrical body 1220 is a rim wall 1221. Rim wall 1221 provides a seat for foaming cartridge 1130. Rim wall 1221 also helps prevent fluid from flowing on the outside of cylindrical housing 1131. Second housing section 1003 also includes a foam outlet 1010. First housing section 1002 and second housing section 1003 may be connected to one another by any means, such as, for example, a friction fit, a threaded fit, a glued connection, a welded connection or the like.

Remote foam generator 1000 has a central axis FGA. Foam outlet 1010 also has a central axis OA. A foam outlet angle A is formed between central axis FGA and central axis OA. In this figure, foam outlet angle A is about 90 degrees. Foam outlet angle A may be less than 90 degrees. Preferably, foam outlet angle A is 90 degrees or greater. Foam outlet angle is between about 90 degrees and about 180 degrees. About as used herein the term “about” should be construed to be within plus or minus 5 degrees. All of the foam outlets described herein may have a foam outlet angle of between about 90 degrees and about 180 degrees.

Diverter 1102 includes a mixing chamber separator 1106. In this exemplary embodiment, mixing chamber separator 1106 is a cylindrical projection extending from wall plate 1210. Mixing chamber separator 1106 separates outer mixing chamber 1502 (FIG. 15) from inner mixing chamber 1504. In this exemplary embodiment, the interior of cylindrical projection forms, at least in part, the outer mixing chamber 1502 and the inner mixing chamber 1504. Mixing chamber separator 1106 has an outer end 1109. Outer end 1109 has a tapered surface 1110. Tapered surface 1110 tapers from the outside wall 1291 of mixing chamber separator 1106 to an interior wall 1292 of mixing chamber separator 1106. As described in more detail below, the tapered surface 1110 aids in directing incoming air into the outer mixing chamber 1502.

Located in the mixing chamber separator 1106 is one or more fluid flow through windows 1120. In this exemplary embodiment, the one or more fluid flow through windows 1120 are rectangular notches. However, fluid flow through windows 1120 may have other shapes, such as, for example, cylindrical channels or apertures through mixing chamber separator 1106. In some embodiments, the one or more fluid flow through windows 1120 may be in a different structure of remote foam generator 1000, provided that they provide a fluid flow path between the outer mixing chamber 1502 and the inner mixing chamber 1504.

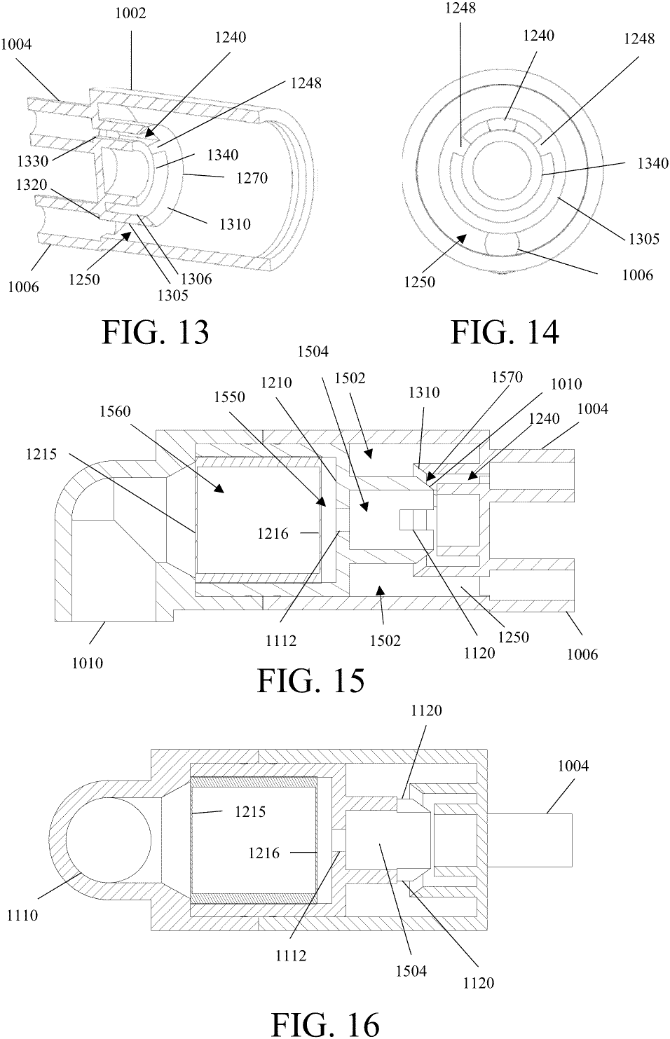

First housing section 1002 includes a first end 1294 and a second end 1295. First end 1294 is open and receives diverter 1102. The second end has an end wall 1296. A first annular projection 1260 extends inward from end wall 1296. A second annular projection 1270 extends inward from end wall 1296 and surrounds first annular projection 1260. Second annular projection 1270 has an outer wall 1305 (FIGS. 13 and 14) and an inner wall 1306. The inner surface 1310 of second annular projection 1270 is tapered or sloped. In this embodiment, inner surface 1310 tapers or slopes downward from the outside wall 1305 to the inside wall 1306.

A pair of ribs 1248 extend inward from end wall 1296 and connect inner wall 1306 of second annular projection 1270 with an outer wall 1340 of the first annular projection to form an air passage 1240 therebetween. An opening 1330 in end wall 1296 creates a fluid flow path from air inlet 1004 to air passage 1240.

Opening 1320 in end wall 1296 places liquid inlet 1006 in fluid communications with annular chamber 1250 (located between second annular projection 1270 and the interior of second housing portion 1002) and outer mixing chamber 1502.

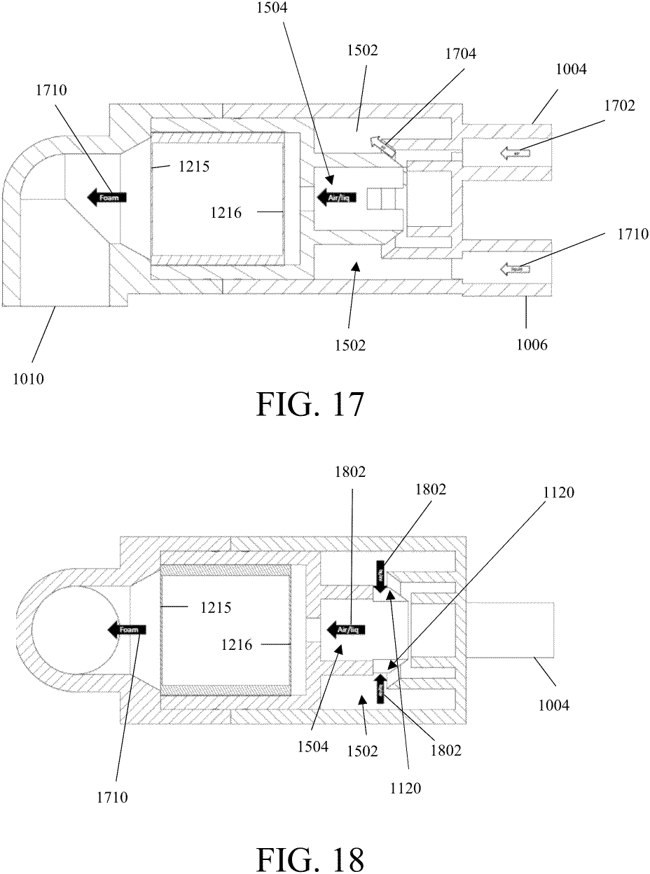

FIGS. 15 and 17 are a cross-sectional view along a vertical axis of the exemplary remote foam generator 1000. FIGS. 14 and 18 are a cross-sectional view along a horizontal axis of the exemplary remote foam generator 1000. Tapered surface 1110 of diverter 1102 is in line with air flow channel 1240. Tapered surface 1110 deflects air 1704 flowing through air channel 1240 outward into outer mixing chamber 1502. Liquid 1710 flowing through liquid flow channel 1250 flows into outer mixing chamber. The liquid and air mix into an air/liquid mixture 1802 and flow through the fluid flow through windows 1120 into the inner mixing chamber 1504. The air/liquid mixture 1802 flow through fluid flow restrictor aperture 1112 into foaming chamber 1550.

Fluid flow restrictor aperture 1112 is a flow restrictor and restricts fluid flow through remote foam generator 1000. In this exemplary embodiment, inner mixing chamber 1504 has a larger cross-sectional area, e.g. diameter, than the cross-sectional area, e.g. diameter, of the fluid flow restrictor aperture 1112. Fluid flowing through the restrictor increases in velocity. Once the fluid is past the fluid flow restrictor aperture 1112, the fluid slows down and expands in foaming chamber 1550 further mixing the air and liquid. The air/liquid mixture flows through the mix media, i.e. screens 1216 and 1215 and is dispensed out of the outlet as a foam.

During operation, the period of time that liquid and air are being pumped is the same amount of time. As a result, air 1704 flowing through air flow channel 1240 prevents liquid from being forced into air flow channel 1240. In addition, tapered surface 1110 and surface 1310 also help prevent liquid from entering air flow channel 1240.

In some embodiments, the cross-sectional area of the inner mixing chamber 1504 is smaller than the cross-sectional area of the foaming chamber 1550. In some embodiments, the cross-sectional area of the foaming chamber 1550 is smaller than the cross-sectional area of the outer mixing chamber 1502.

In some embodiments, the air inlet 1004 and the liquid inlet 1006 are located along a first plane. In some embodiments, there are two fluid flow windows 1120. In some embodiments, the fluid flow windows 1120 are located in a second plane. In some embodiments, the first plane and the second plane are not parallel. In some embodiments, the first plane and the second plane intersect at about a 90 degree angle.

In some embodiments, air flowing through air flow channel 1240 is directed upward into the outer mixing chamber 1502. In some embodiments, air inlet 1004 and liquid inlet 1006 are located along a vertical axis. In some embodiments, one or more fluid flow windows 1120 are located along a horizontal axis. In some embodiments, there are two fluid flow windows.

The exemplary remote foam generator provides a uniform foam output. The uniform output has a consistent density throughout the dispense. The term consistent as used herein means that the diameter of the bubbles are within +/- 10% of the average bubble diameter.

While the present invention has been illustrated by the description of embodiments thereof and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and illustrative examples shown and described. Accordingly, departures may be made from such details without departing from the spirit or scope of the applicants’ general inventive concept.

1. A foam dispenser comprising:
a housing;
a liquid reservoir;
a liquid pump chamber;
an air pump chamber;
a remote foam generator;
wherein the remote foam generator is at least 3 inches from the liquid pump chamber and the air pump chamber;
the remote foam having;
a housing;
a liquid inlet;
an air inlet;
a central axis;
the air inlet is located above the central axis;
the liquid inlet is located below the central axis;
an inner mixing chamber;
an outer mixing chamber;
a deflector;
the deflector having a first surface angled to deflect air flowing from the air inlet into the outer mixing chamber;
the liquid inlet directing liquid flow into the outer mixing chamber;
one or more fluid flow windows placing the outer mixing chamber in fluid communications with the inner mixing chamber;
a foaming chamber;
one or more mix media located in the foaming chamber; and
a foam outlet.

2. The foam dispenser of claim 1 further comprising a fluid flow restrictor located between the inner mixing chamber and the foaming chamber.

3. The foam dispenser of claim 1 wherein the one or more fluid flow windows is located through at least a portion of the deflector.

4. The foam dispenser of claim 1 further comprising a mixing chamber separator.

5. The foam dispenser of claim 4 wherein the deflector is an angled surface of the mixing chamber separator, wherein the angled surface is located in an air flow path extending from the air inlet.

6. (canceled)

7. The foam dispenser of claim 1 further comprising an inner cylindrical projection and an outer cylindrical projection, and wherein the air flow passage extends between the inner cylindrical projection and the outer cylindrical projection.

8. The foam dispenser of claim 7 further comprising a pair of ribs extending between the inner cylindrical projection and the outer cylindrical projection, and wherein the air flow passage extends between the pair of ribs.

9. The foam dispenser of claim 7 wherein the inner surface of the outer cylindrical projection is angled to match the angle of the deflector.

10. The foam dispenser of claim 1 wherein the foam outlet has a central axis and wherein the angle between the central axis of the foam outlet and the central axis of the foam generator is between about 90 degrees and about 180 degrees.

11. A remote foam generator that is configured to mix air and liquid at a location away from one or more pumps that pump air and liquid separately to the remote foam generator comprising:
a cylindrical housing;
an end wall;
a liquid inlet extending outward from the end wall;
an air inlet extending outward from the end wall;
the cylindrical housing has a central axis;
a center of the air inlet is located closer to the central axis than a center of the liquid inlet;
an inner cylindrical projection extending inward from the end wall;
an outer cylindrical projection extending inward from the end wall;
the air inlet in fluid communication with an area between the inner cylindrical projection and the outer cylindrical projection;
the liquid inlet in fluid communication with an area between the outer cylindrical projection and an inside wall of the cylindrical housing:
an outer mixing chamber;
an inner mixing chamber;
a deflector;
the deflector having
a mixing chamber separator; and
a deflecting surface;
wherein the deflecting surface deflects air flowing from the air inlet into the outer mixing chamber;
a foaming chamber;
one or more mix media located in the foaming chamber; and
a foam outlet.

12. The foam generator of claim 11 further comprising a flow restrictor located between the inner mixing chamber and the foaming chamber.

13. (canceled)

14. The foam generator of claim 11 wherein the cross-sectional area of the inner mixing chamber is smaller than the cross-sectional area of the foaming chamber.

15. The foam generator of claim 11 wherein the cross-sectional area of the foaming chamber is smaller than the cross-sectional area of the outer mixing chamber.

16. (canceled)

17. (canceled)

18. (canceled)

19. A foam dispenser comprising:
a housing;
a liquid reservoir;
a liquid pump chamber;
an air pump chamber;
a remote foam generator;
wherein the remote foam generator is at least 3 inches from the liquid pump chamber and the air pump chamber;
the remote foam generator having;
a cylindrical housing;
a liquid inlet;
an air inlet;
the air inlet located above the liquid inlet;
an inner mixing chamber;
an outer mixing chamber;
the outer mixing chamber having an interior wall;
a first air passage directing the air into the outer mixing chamber;
the first air passage having an outer wall;
the outer wall of the first air passage located away from the interior wall of the outer mixing chamber;
the liquid inlet directing liquid flow into the outer mixing chamber;
one or more fluid flow windows placing the outer mixing chamber in fluid communications with the inner mixing chamber;
a foaming chamber;
one or more mix media located in the foaming chamber; and
a foam outlet.

20. The foam dispenser of claim 19 further comprising a fluid flow restrictor located between the inner mixing chamber and the foaming chamber.

21. (canceled)

22. The foam dispenser of claim 19 further comprising a deflector, wherein the deflector comprises an angled surface to deflect the air into the outer mixing chamber.

23. (canceled)

24. (canceled)

25. The foam dispenser of claim 19 wherein an outer surface of the interior wall of the outer mixing chamber is an angled surface, wherein the angled surface is located in an air flow path extending from the air inlet.

26. The foam dispenser of claim 19 wherein the one or more fluid flow windows are located along a horizontal axis.

27. The foam dispenser of claim 19 further comprising an inner cylindrical projection and an outer cylindrical projection, and wherein the air flow passage extends between the inner cylindrical projection and the outer cylindrical projection.

28. (canceled)

29. (canceled)

30. The foam dispenser of claim 19 wherein the foam outlet has a central axis and wherein the angle between the central axis of the foam outlet and the central axis of the foam generator is between about 90 degrees and about 180 degrees.
